(19) United States
(12) Patent Application Publication
(10) Pub. No.: US 2012/0130607 A1
(43) Pub. Date: May 24, 2012

(54) METHOD FOR EARLY DETECTION OF DAMAGE IN A MOTOR VEHICLE TRANSMISSION

(75) Inventors: Hubert Koenig, Meckenbeuren (DE); Joerg Kurth, Meckenbeuren (DE)

(73) Assignee: ZF FRIEDRICHSHAFEN AG, Friedrichshafen (DE)

(21) Appl. No.: 13/387,837

(22) PCT Filed: Jul. 14, 2010
(86) PCT No.: PCT/EP10/60100

§ 371 Date: Jan. 30, 2012

(30) Foreign Application Priority Data
Aug. 10, 2009 (DE) 10 2009 028 364.1

(51) Int. Cl. G01M 13/02

(52) U.S. Cl. 701/51

(57) ABSTRACT

A method of early recognition of damage in a motor vehicle transmission which comprises at least one acceleration sensor, with which mechanical vibrations in the motor vehicle transmission are detected and converted into an electrical signal. The electrical signal is then digitalized and thereafter carrying our a comparison with a comparison parameter. The mechanical vibrations are detected at defined operating points of the motor vehicle transmission and, from the digitalized electrical signal acceleration amplitudes, are determined over a time interval. A count is taken of conditions in which the acceleration amplitudes exceed the comparison parameter and, with reference to the number of such conditions, a calculated probability of damage in the motor vehicle transmission is determined. A motor vehicle transmission whose damage can be determined by the method, and a computer program product for carrying out the individual process steps are also proposed.

This application is a National Stage completion of PCT/EP2010/060100 filed Jul. 14, 2010, which claims priority from German patent application serial no. 10 2009 028 364.1 filed Aug. 10, 2009.

### FIELD OF THE INVENTION

The invention concerns a method for the early detection of damage in a motor vehicle transmission that comprises at least one acceleration sensor by which mechanical vibrations in the motor vehicle transmission are detected and converted into an electrical signal, the electrical signal then being digitalized and thereafter compared with a comparison parameter. The invention also concerns a motor vehicle transmission in which damage can be determined in accordance with the method, and a computer program product for carrying out the individual process steps.

### BACKGROUND OF THE INVENTION

Transmission control systems of modern motor vehicle transmissions often comprise diagnostic devices by virtue of which, if damage occurs, additional consequential damage to other components can be avoided by initiating appropriate measures, for example by imposing a lower transmission input speed. In some systems sensors are also used, by which vibrations in the motor vehicle transmission can be detected, which in the event of larger amplitudes indicate that a transmission component has been damaged. Thus, by monitoring the vibrations, damage can be recognized at an early stage and so can also be corrected earlier, thereby reducing the risk that more serious consequential damage may occur.

From DE 101 44 076 A1 a method for the early recognition of damage in a motor vehicle transmission is known, in which vibrations of the motor vehicle transmission are detected by an acceleration sensor and converted by the latter into an electrical signal. The electrical signal produced is then digitalized and transformed in its frequency range by Fourier transformation. After this the data so obtained are converted again by a cepstrum analysis over a time interval, so that resonance data from individual impulses in the time interval are obtained. These resonance data, also referred to as a cepstrum, are then compared with a comparison parameter in the form of a master cepstrum, and if this is exceeded damage is diagnosed.

However, the above-mentioned method has the considerable disadvantage that to carry out the Fourier transformation and the cepstrum analysis considerable computing effort is required. Accordingly, in the area of a motor vehicle transmission, a control unit with large memory capacity and high computing power must be provided, and this considerably increases the production costs.

### SUMMARY OF THE INVENTION

Thus, the purpose of the present invention is to make available a method for the early detection of damage in a motor vehicle transmission, which can be carried out with little computing effort so that it can be used in the area of a transmission control system with acceptable computing power. However, at the same time reliable damage recognition must be ensured.

In terms of method this objective is achieved, in conjunction with the characterizing features of the method. From the equipment standpoint the objective is solved, starting with a motor vehicle transmission, in conjunction with its characterizing features. A computer program and a data carrier for storing it are used for implementing the invention.

The invention is based on the technical principle that mechanical vibrations in the motor vehicle transmission are detected at defined operating points and, from the digitalized electrical signal, acceleration amplitudes are determined over a time period. Furthermore, during this a count is taken of conditions when the acceleration amplitudes exceed a comparison parameter, and with reference to the number of such conditions a calculated probability of damage in the motor vehicle transmission is determined.

By means of the method according to the invention damage in the motor vehicle transmission can be determined with little computing effort and thus the method can be implemented using a smaller memory and less computing power. This is because the acceleration signals produced and then digitalized do not first have to be transformed in their frequency range with the help of a Fourier transformation and then converted again, over a time interval, by means of a cepstrum analysis, but rather, they are compared directly with an associated comparison parameter. Since this only takes place at particular operating points of the motor vehicle transmission at which good comparability with a reference parameter is possible, deviations between the accelerations detected, i.e. the mechanical vibrations in the transmission, and the associated reference can be determined with sufficient accuracy. By determining the probability of damage from the count of conditions in which the acceleration amplitudes exceed the comparison parameter, damage that has occurred in the motor vehicle transmission can also be reliably recognized since this directly influences the damage probability by virtue, in such a case, of the continually occurring conditions. Thus, all in all, reliable damage recognition in the motor vehicle transmission is ensured with little computing effort and the associated rapidity of implementation.

In an embodiment of the invention, in addition to the comparison of the acceleration amplitudes with the comparison parameter, the conditions are determined by comparing acceleration gradients with a limit value and with reference to a subsequent detection of elevated acceleration gradients in the electrical signal. In this case it is expedient to use at least one gradient limiter which filters out physically impossible gradients. By virtue of the additional monitoring of acceleration gradients in the signal, the accuracy of damage recognition can be increased. Thanks to the use of at least one gradient limiter, gradients which physically cannot occur in the transmission are ignored.

In a further development of the invention, the calculated probability increases with each condition recognized, whereas time intervals without recognized conditions bring about a reduction of the probability. This has the advantage that continually occurring high acceleration amplitudes and gradients ensure a steady increase of the calculated probability, whereas acceleration peaks that occur only once increase the calculated probability for a short time, but in the absence of further excesses, the probability is then reduced again. Thus, this measure makes it possible to reliably distinguish between one-time events and recurrent conditions, which allow a conclusion about transmission damage.

A further design feature of the invention is that the calculated probability is compared with a threshold value which, if exceeded, leads to the diagnosis of motor vehicle transmission damage. Expediently, a damage diagnosis is indicated and/or shown on a display. Thus, by virtue of this measure, if the threshold value is exceeded the system concludes that damage has occurred and this is correspondingly registered. It is then conceivable to alert the driver of the motor vehicle by means of a display, perhaps in the form of a shortened maintenance interval. Furthermore however, this damage recognition can also be stored in a defect memory of the motor vehicle's control electronics system and displayed to the customer servicing facility at the next maintenance interval so as to call for selective checking. In this way it is also possible to reach retrospective conclusions about particular driving conditions, such as overloading or misuse.

In accordance with a further advantageous embodiment of the invention, the defined operating points consist of characteristic operating ranges in which slight mechanical vibrations of the motor vehicle transmission are usually predominant. Thanks to this measure an optimum comparison can be effected between the digitalized electrical signal and the limit parameter, since interfering influences are eliminated as much as possible. The operating points can thus be located in ranges in which the transmission runs predominantly quietly and in which no load changes are to be expected.

The system according to the invention can also be incorporated as a computer program product which, when it is run on a processor of a transmission control unit of the motor vehicle transmission, induces the processor by software means to carry out the associated process steps in accordance with the object of the invention.

In this connection the object of the invention includes a computer-readable medium on which a computer program product as described above is stored and from which it can be called up.

### BRIEF DESCRIPTION OF THE DRAWINGS

Below, further measures that improve the invention are shown in combination with the description of a preferred embodiment of the invention and with reference to figures, which show:

FIG. 1: A flow chart of the method according to the invention;

FIG. 2: The variation of an acceleration signal over time and

FIG. 3: A number of diagrams from which, as a function of time, the conditions occurring, the generation of a calculated probability and a damage diagnosis can be seen.

### DETAILED DESCRIPTION OF THE PREFERRED EMBODIMENTS

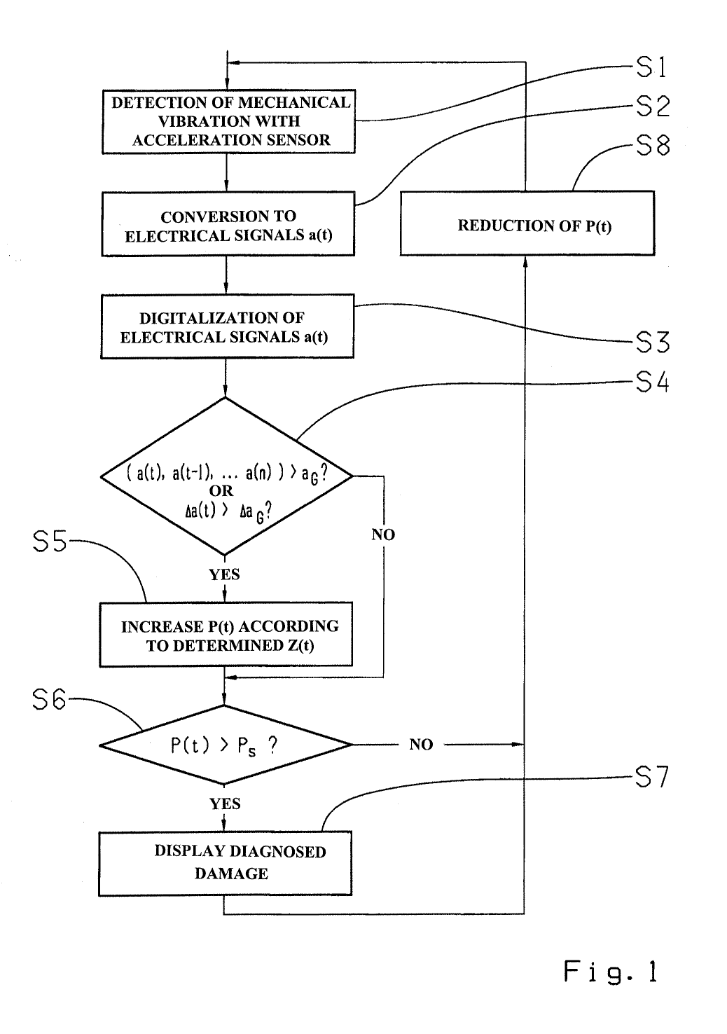

FIG. 1 shows a flow chart of the method according to the invention. For this, at the beginning, in a first step S1 mechanical vibrations in a motor vehicle transmission are detected by at least one acceleration sensor located in the area of transmission components whose functionality is to be monitored. In a step S2 the mechanical vibrations detected by the at least one acceleration sensor are converted to an electrical signal a(t) which is digitalized in a subsequent step S3. Acceleration amplitudes obtained from the signal a(t) are then compared in the next step S4 with a comparison parameter a_{G}. In addition the acceleration gradients Δa(t) in the signal a(t) are determined and compared with a limit value Δa_{G}. During this, however, to filter out interfering effects from the acceleration gradients Δa(t) determined and disregard them for the purposes of the comparison, at least one gradient limiter is used to reject physically impossible values.

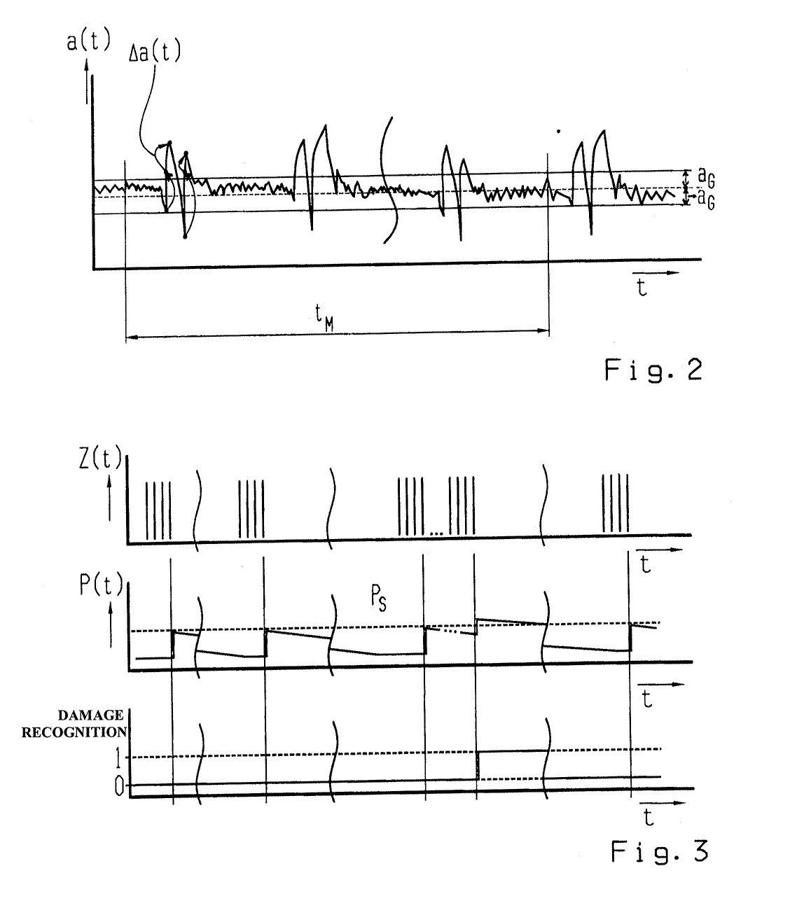

For this process FIG. 2 shows an example variation of a signal a(t) over time t. As can be seen, over a measurement period t_{M}, an amplitude range set by the comparisons parameter a_{G} is exceeded at three time points by elevated acceleration amplitudes. These excesses are detected by the system. The determination of the associated acceleration gradient Δa(t) is demonstrated, as an example, in the area of the first time the comparison parameter a_{G} is exceeded.

Continually occurring mechanical vibrations indicate the threat of transmission component failure. Damage to bearings, gear teeth and synchronizers produces noise and hence also mechanical vibrations, which can be detected by the acceleration sensor. The detection and comparison with the comparison parameter a_{G} and the limit value Δa_{G} are effected at operating points of the motor vehicle transmission at which, usually, quiet running and no load change are to be expected. The measurement period t_{M} must be chosen such that reliable information about mechanical vibrations can be obtained.

If now it is determined in step S4 that the comparison parameter a_{G} or the limit value Δa_{G} has been exceeded, then in the following step S5 a count is taken of the number of conditions Z(t) when such excesses occur. In accordance with the number of conditions Z(t) the value of a calculated probability P(t) is increased. Thereafter, the system progresses to a further step S6. On the other hand, if the comparison in step S4 yields a negative result, a direct transition to step S6 takes place. In step S6 it is questioned whether the calculated probability P(t) has exceeded a threshold value P_{S}. If so, then in the next step S7 damage in the motor vehicle transmission is diagnosed and this diagnosis is notified. For example, that can take place by alerting a driver of the motor vehicle concerned that damage in the transmission has been recognized, by means of a display, or by indicating that a maintenance interval has been shortened. Furthermore, in that event the damage recognition can at the same time be stored in a defect memory of a control unit of the motor vehicle's electronic system, so that it can be indicated whenever next the motor vehicle is inspected. After step S7 the system progresses to a step S8 in which the calculated probability P(t) is reduced again. If no exceeding of the threshold value P_{S} has been recognized, the system can also progress directly from step S6 to step S8. After step S8 the system then jumps back to before step S1 and the method steps are repeated.

The reduction of the calculated probability P(t) in step S8 has the consequence that only continually occurring excesses above the comparison parameter a_{G} or the limit value ΔA_{G} result in a steady increase of the calculated probability P(t). In the event of individual, large mechanical vibrations, which can sometimes take place due to outside influences, although it is true that conditions Z(t) when the magnitudes a_{G} and Δa_{G} have been exceeded are detected and the calculated probability P(t) is increased, if such events do not recur during the continuing progression through the process the calculated probability P(t) is reduced step by step so that if another isolated event occurs, no damage diagnosis is triggered as a result of the measurement.

In FIG. 3 example time variations of the conditions Z(t) determined, the calculated probability P(t) and the recognition of damage in the motor vehicle transmission are shown one under the other. In the topmost diagram, conditions Z(t) when the acceleration signal a(t) exceeds the comparison parameter a_{G} or when the acceleration gradient Δa(t) in the signal a(t) exceeds the limit value Δa_{G} are indicated by vertical lines. Corresponding to these detected conditions Z(t), the calculated probability P(t) is then increased as shown in the diagram immediately below. In the case of the first two detected conditions Z(t) of elevated vibrations, however, the time between them—here shown as interrupted—is long enough for the probability P(t) to be reduced again in steps so that it does not rise above the threshold value P_{S}. In this case a signal indicating recognized transmission damage remains at the value 0 in the lowest diagram, which means that damage of the motor vehicle is regarded as improbable. In the case of the third event, however, the detected conditions Z(t) follow so closely after one another in time that the calculated probability P(t) rises above the threshold value P. The result of this is that the signal in the lowest diagram changes to the value 1, which stands for a high probability of transmission damage. Consequently, a corresponding damage diagnosis is issued.

Thus, by virtue of the method according to the invention damage in a motor vehicle transmission can be recognized early and with little computing effort. Since during this only continually recurrent events bring about a change of the probability P(t) of damage in the motor vehicle transmission, and since in addition a comparison of an acceleration signal a(t) with the comparison parameter a_{G} and the limit value Δa_{G} is only carried out at defined operating points of the motor vehicle transmission, high reliability of this damage recognition can be achieved.

### INDEXES

S1-S8 Method steps
a(t) Signal
a_{G} Comparison parameter
Δa(t) Acceleration gradient
Δa_{G} Limit value

### t Time

t_{M} Measurement duration

### Z(t) Conditions

P(t) Calculated probability
P_{S} Threshold value

1-10. (canceled)

11. A method for early recognition of damage in a motor vehicle transmission which comprises at least one acceleration sensor, the method comprising the steps of:
detecting (S1) mechanical vibrations at defined operating points of the motor vehicle transmission with the at least one acceleration sensor;
converting (S2) the mechanical vibrations into an electrical signal (a(t));
digitizing (S3) the electrical signal (a(t));
comparing (S4) the digitized electrical signal (a(t)) with a comparison parameter (aG);
determining acceleration amplitudes from the digitized electrical signal (a(t)) over a time interval (t);
taking a count of conditions (Z(t)) in which the acceleration amplitudes exceed the comparison parameter (aG); and
determining a calculated probability (P(t)) of damage in the motor vehicle transmission with reference to the count of conditions (Z(t)) in which the acceleration amplitudes exceed the comparison parameter (aG).

12. The method according to claim 11, further comprising the step of determining the conditions (Z(t)) in which the acceleration amplitudes exceed the comparison parameter (aG) by comparing acceleration gradients (Δa(t)) with a limit value (ΔaG) and with reference to detection of elevated acceleration gradients in the electrical signal (a(t)) in addition to the comparison of the acceleration amplitudes with the comparison parameter (aG).

13. The method according to claim 12, further comprising the step of utilizing at least one steepness limiter in the comparison of the acceleration gradients (Δa(t)) with the limit value (ΔaG) to filter out physically impossible gradients.

14. The method according to claim 11, further comprising the step of increasing the calculated probability (P(t)) by each count of conditions (Z(t)) in which the acceleration amplitudes exceed the comparison parameter (aG) and reducing the calculated probability (P(t)) in an absence of conditions (Z(t)) in which the acceleration amplitudes exceed the comparison parameter (aG) over a time interval.

15. The method according to claim 11, further comprising the step of the comparing (S6) the calculated probability (P(t)) with a threshold value (PS), and diagnosing damage in the motor vehicle transmission if the calculated probability (P(t)) exceeds a threshold value (PS).

16. The method according to claim 15, further comprising the step of at least one of recording a damage diagnosis and indicating damage diagnosis on a display (S7).

17. The method according to claim 11, further comprising the step of the forming defined operating points by characteristic operating ranges in which mild mechanical vibrations of the motor vehicle transmission usually predominate.

18. A motor vehicle transmission comprising at least one acceleration sensor located in an area of transmission components where the at least one acceleration sensor detects mechanical vibrations and converts the mechanical vibrations into an electrical signal (a(t)), and determining damage in the area of the transmission components, with reference to the electrical signal (a(t)), by a method comprising the steps of:
detecting (S1) the mechanical vibrations in an area of transmission components with the at least one acceleration sensor,
converting (S2) the mechanical vibrations into the electrical signal (a(t)),
digitizing (S3) the electrical signal (a(t)),
comparing (S4) the digitized electrical signal (a(t)) with a comparison parameter (aG),
determining acceleration amplitudes from the digitized electrical signal (a(t)) over a time interval (t),
taking a count of conditions (Z(t)) in which the acceleration amplitudes exceed the comparison parameter (aG), and
determining a calculated probability (P(t)) of damage in the area of transmission components with reference to the count of conditions (Z(t)) in which the acceleration amplitudes exceed the comparison parameter (aG).

19. A computer program product for a motor vehicle transmission having corresponding control commands stored in a software system which are implemented for carrying out a method comprising steps of:
detecting (S1) mechanical vibrations at defined operating points of the motor vehicle transmission with at least one acceleration sensor;
converting (S2) the mechanical vibrations into an electrical signal (a(t));
digitizing (S3) the electrical signal (a(t));
comparing (S4) the digitized electrical signal (a(t)) with a comparison parameter (aG);
determining acceleration amplitudes from the digitized electrical signal (a(t)) over a time interval (t);
taking a count of conditions (Z(t)) in which the acceleration amplitudes exceed the comparison parameter (aG); and
determining a calculated probability (P(t)) of damage in the motor vehicle transmission with reference to the count of conditions (Z(t)) in which the acceleration amplitudes exceed the comparison parameter (aG).

20. A data carrier with a computer program product for a motor vehicle transmission having corresponding control commands stored in a software system which are implemented for carrying out a method comprising steps of:
detecting (S1) mechanical vibrations at defined operating points of the motor vehicle transmission with at least one acceleration sensor;
converting (S2) the mechanical vibrations into an electrical signal (a(t));
digitizing (S3) the electrical signal (a(t));
comparing (S4) the digitized electrical signal (a(t)) with a comparison parameter (aG);
determining acceleration amplitudes from the digitized electrical signal (a(t)) over a time interval (t);
taking a count of conditions (Z(t)) in which the acceleration amplitudes exceed the comparison parameter (aG); and
determining a calculated probability (P(t)) of damage in the motor vehicle transmission with reference to the count of conditions (Z(t)) in which the acceleration amplitudes exceed the comparison parameter (aG).
